(19) United States
(12) Patent Application Publication
(10) Pub. No.: US 2006/0109189 A1
(43) Pub. Date: May 25, 2006

(54) Radiating aperture waveguide feed antenna

(76) Inventors: Philippe Minard, Saint Medard Sur Ille (FR); Ali Louzir, Rennes (FR); Jean-Francois Pintos, Bourgbarre (FR); Philippe Chambelin, Chateaugiron (FR)

Correspondence Address: THOMSON LICENSING INC., PATENT OPERATIONS, PO BOX 5312, PRINCETON, NJ, 08543-5312, US

(21) Appl. No.: 10/996,771

(22) Filed: Nov. 24, 2004

(51) Int. Cl. H01Q 13/00

(52) U.S. Cl. 343/772

(57) ABSTRACT

The invention proposes a primary feed providing an asymmetrical illumination compatible with an elliptical reflector and having a small space requirement. The invention uses a short rod to modify the radiation of an open waveguide section. The invention is an antenna comprising a radiating feed made up of a waveguide, one end of the waveguide forming a radiating aperture. The end forming the radiating aperture is fitted with a rod made of dielectric material, said rod being partly inserted in the waveguide. The rod is extended outside the waveguide over a length less than twice the guided wavelength and the section of the rod develops outside the waveguide differently in each of the planes.

### FIELD OF THE INVENTION

The invention relates to a radiating aperture waveguide feed antenna. This type of feed can be combined with a parabolic reflector.

### BACKGROUND OF THE INVENTION

For certain types of radio transmission requiring directional antennas, the use of antennas with reflectors, in particular parabolic, with a feed and a focusing point, is known. This is the type of antenna that is used, among other things, for satellite transmissions that use the C, Ku and Ka bands.

Reflector antennas are normally concave dishes, the surface of which corresponds to an axisymmetric portion of a parabola. The space requirement of circular reflectors is normally large. From a commercial point of view, the use of a reflector with an elliptical aperture may be more attractive than a reflector with a circular aperture, in particular when the feed is offset relative to the focusing point of the reflector. In practice, the space requirement of a reflector with an elliptical aperture is visually more compact than that of a reflector with a circular aperture. Moreover, for multi-satellite reception using a single parabola, it is more advantageous, in particular for minimizing the losses and distortions associated with defocusing, to use an elliptical aperture reflector.

To optimize the illumination of these elliptical reflectors, primary feeds must offer radiation pattern apertures suited to these elliptical reflectors. In practice, the maximum effectiveness of a reflector antenna is obtained when the illumination of the reflector by the feed provides a gain at the rim of the reflector of between −10 and −13 dB. For this, the two mutually perpendicular planes of the radiation pattern must present quite different apertures.

As an example, to illuminate an elliptical reflector that is 50 cm high and 90 cm wide and has a focal length of 52 cm at the 12 GHz frequency, the apertures of the radiation pattern of the primary feed should be 28° for the lighting in the vertical plane (minor axis of the ellipse) and 45° for the lighting in the horizontal plane (major axis of the ellipse) for an illumination level at the edges of the reflector of −12 dB.

Techniques that can be used in a general way to equalize or unbalance the radiation patterns in the E and H planes of primary antenna feeds are described in the “Antenna Engineering Handbook” by Henri Jasik, Chapter 15. One example is the use of horns with a rectangular aperture and multimode horns.

It would also be possible to obtain unbalanced lighting effects using printed arrays, for example, a four-element array disposed on a rectangle.

All these primary feeds have relatively large transverse space requirements and cannot be used for multi-satellite reception from satellites occupying very near orbital positions. Furthermore, if these terminals are designed for consumer use, the complex primary feeds must therefore be excluded.

If the space requirement of a conventional primary feed is calculated at 12 GHz, the result is a horn with a diameter of 40 mm, or a patch array with a diameter of 45-50 mm. From this dimensioning, if two independent feeds are used with an angular separation between satellites of 4°, the focal centres must be approximately 34 mm apart, which cannot be considered given the dimensions.

Moreover, a simple open rectangular waveguide (without horn) that has a less bulky cross section, even it has two different radiation pattern apertures, will not offer good apertures because it is not directional enough.

Also known is the use of travelling wave dielectric rods. This type of rod then replaces the horn. However, such rods cannot be used because, to obtain an aperture at −12 dB of around 45° would require a length equal to approximately three times the wavelength, and to obtain an aperture of approximately 28° would require a length of approximately ten times the wavelength. Now it is not possible to have a rod with a length that is both equal to three times the wavelength and equal to ten times the wavelength. Moreover, ten times the wavelength at a frequency of 12 GHz corresponds to approximately 25 cm which, on the one hand, is relatively large and, on the other hand, raises the risk of disturbing a nearby feed of the same dimensions.

Thus, the use of a known feed will not satisfy the fixed constraints.

### BRIEF SUMMARY OF THE INVENTION

The invention provides a solution to the problem described above by proposing a primary feed which provides an asymmetrical illumination compatible with an elliptical reflector and having a small space requirement. The invention uses a short rod to modify the radiation of an open waveguide section.

The invention is an antenna comprising a radiating feed made up of a waveguide with a section having at least two planes of symmetry perpendicular to each other, each plane extending in the axis of propagation of the waves, one end of the waveguide forming a radiating aperture. The end forming the radiating aperture is fitted with a rod made of dielectric material, said rod being partly inserted into the waveguide and filling the section of the waveguide over a defined length. The rod is extended beyond the waveguide over a length less than twice the guided wavelength and the section of the rod develops outside the waveguide differently in each of the planes.

Preferably, the development of the section of the rod outside the waveguide can be linear but in a different direction in each of the two planes. In one of the planes, the rod can become larger and in the other plane the rod can become smaller. The waveguide can be of square, rectangular or circular section. The end of the rod located outside the waveguide has a section with a shape different from the section of the waveguide.

The waves that circulate in the waveguide can be polarized waves. When the polarized waves are of linear polarization perpendicular to the axis of propagation of the waves and in two different directions, each direction is included in one of the two planes, and the shape of the rod outside the waveguide is symmetrical in relation to each of the two planes.

### BRIEF SUMMARY OF THE DRAWINGS

The invention will be better understood, and other features and advantages will become apparent on reading the description that follows, the description referring to the appended drawings in which:

FIG. 1 represents an example of a feed according to the invention in perspective view,

FIG. 2 represents an example of a feed according to the invention in partial cross-section according to a first cutting plane,

FIG. 3 represents an example of a feed according to the invention in partial cross section according to a second cutting plane at right angles to the first cutting plane,

FIG. 4 represents an example of a feed according to the invention as seen by the reflector,

FIG. 5 shows radiation curves according to a first dimensioning of the invention,

FIG. 6 shows radiation curves according to a second dimensioning of the invention.

### DESCRIPTION OF PREFERRED EMBODIMENTS

The principle applied by the invention consists in modifying the radiation of a simple waveguide using a short dielectric rod. Since the radiation of a waveguide is imposed, for a given frequency, by the cross section of the waveguide, it cannot be adapted to light an elliptical reflector. The short rod modifies the distribution of the field in the aperture formed by the waveguide fitted with the rod. The resulting radiation pattern is modified without the rod acting as a travelling wave feed. The fields are distributed in the equivalent aperture in such a way as to obtain a radiation pattern suited to illuminating an elliptical area.

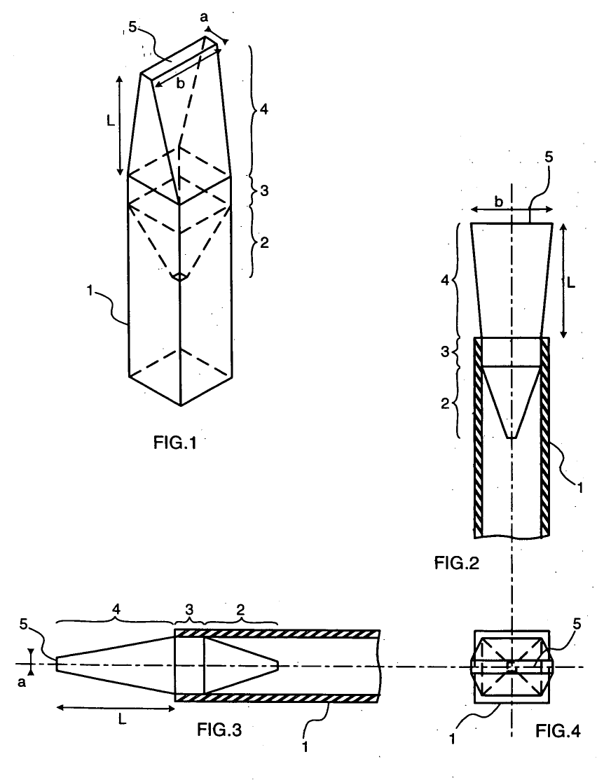

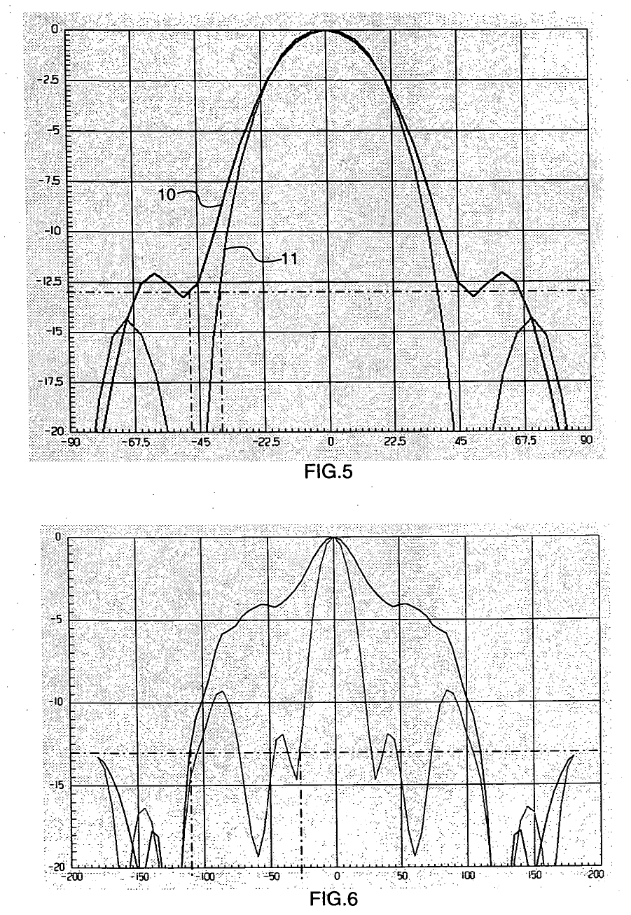

FIGS. 1 to 4 show an exemplary embodiment of a feed according to the invention from different views. In the example described, the feed comprises a waveguide 1, typically of square section, one end of which forms a radiating aperture. The waveguide is dimensioned according to a known technique to obtain a guided length roughly equal to the average wavelength to be received or sent which is, for example, 12 GHz, the section of the waveguide then being 21 mm×21 mm. A dielectric rod is placed in the radiating aperture. The rod is made of a dielectric material with low losses and a relative permittivity greater than 1. This material can be a plastic such as, for example, polystyrene, polypropylene or any other compound dielectric material normally made up of a light plastic material base, filled with a ceramic type high permittivity material, used to control the value of the relative permittivity of the resulting rod.

The rod comprises three parts, 2 to 4. A first part 2 provides impedance matching to pass from the empty waveguide to the dielectric material with losses minimized. The first part 2 is dimensioned according to known rules of wave propagation in a waveguide by changing the propagation medium. The first part 2 is normally made up of a conical trunk, the section of which corresponds to the section of the waveguide 1. A second part 3 matches the shape of the waveguide 1. The second part 3 is used to hold the rod in position at the end of the waveguide 1, the length of this second part 3 securing the rod mechanically. The third part 4 is used to collimate the radiation of the radiation aperture of the waveguide 1. The third part 4 develops differently in each of the two planes passing on the one hand through the axis of propagation and on the other hand through each of the axes of symmetry of the illuminated ellipse.

The invention lies mainly in the third part 4 of the rod which determines the radiation pattern of the feed. The length L of this third part 4 forms an impedance matching-length between the section of the waveguide and a radiating surface 5.

The radiating surface 5 is calculated according to a known method of calculating an equivalent radiation aperture. The radiating apertures can have widely varying shapes, but to simplify the calculations, it is possible to choose a rectangular radiating surface which provides a quasi-elliptical radiation pattern. After having dimensioned the radiating surface 5, the length L is determined to obtain an impedance matching optimized for a minimum length, according to a known technique. To simplify the production of the rod, an optimized linear impedance matching is used, which develops differently in each of the two planes. As an example, to obtain an elliptical radiation pattern having an aperture at −13 dB of 50° along the major axis of the ellipse and 38° along the minor axis of the ellipse, the result is a rectangular radiating surface 5 with a section a×b=3 mm×23 mm. The length is then calculated to pass from the section of the waveguide 1 to the radiating surface 5 with an optimized impedance matching resulting in a length L=35 mm.

FIG. 5 shows the radiation pattern obtained by simulation for this dimensioning. The vertical scale represents the gain and the horizontal scale represents the aperture angle relative to the centre of the beam. The curve 10 shows the radiation pattern in the plane corresponding to the major axis of the ellipse which is defined by the width dimension B of the radiating surface 5. The curve 11 shows the radiation pattern in the plane corresponding to the minor axis of the ellipse which is defined by the width dimension a of the radiating surface 5. A person skilled in the art can see that 48° and 37° are obtained. Given the required radiation pattern, such a result can be highly appropriate. However, if a pattern closer to the required pattern is desired, it is still possible to adjust the dimensions a and b of the radiating surface 5 and to make use of successive simulations to optimize these dimensions.

As a complementary example, to demonstrate the possibilities offered with this type of feed, a dimensioning of the radiating surface such that a=6 mm and b=36 mm and the length L=25 mm provides the result shown in FIG. 6. A person skilled in the art can see that the aperture angles become equal to 110° for the major axis and 28° for the minor axis of the ellipse. It is possible with this technique to obtain a very wide range of options.

Following on from the two dimensionings, a person skilled in the art can see that the length L can be roughly the same as the guided wavelength. This length L can even be less than the wavelength if the differences between the section of the waveguide 1 and the radiating surface 5 allow it. It is also possible to have a shorter length if an exponential matching profile is used instead of a linear one, but this adds somewhat to the complexity for production.

The preferred example can be used equally well with non-polarized waves and with polarized waves. However, when waves with a linear polarization are used, it is essential to check that the phase differences introduced by the dielectric rod are the same for the two orthogonal polarization directions. This condition is easily satisfied because all that is needed is a symmetrical rod in the longitudinal planes containing the direction of propagation of the waves and the polarization directions.

In the case of a circular polarization of the waves, the polarizer must be dimensioned taking into account the external shape of the rod. The first impedance matching part is no longer conical but acts as a polarizer by introducing a phase difference between two mutually perpendicular components of the electrical field to generate the circular polarization. Any depolarizations generated by the external part of the rod must also be compensated by the polarizer.

The preferred example shows that the rod becomes larger on one side and smaller on the other side. It is, however, possible for the radiating surface to be such that the rod becomes larger or smaller simultaneously at both ends.

The preferred example uses a square section waveguide. Obviously, any waveguide profile, for example circular or rectangular, can be used provided that the waveguide accepts two symmetrical planes perpendicular to each other. One interest of the invention is to obtain a radiating surface of a shape different from the section of the waveguide and this independently of the section of the waveguide.

What is claimed is:

1. Antenna comprising a radiating feed made up of a waveguide of a section having at least two planes of symmetry perpendicular to each other, each plane extending in the axis of propagation of the waves, one end of the waveguide forming a radiating aperture, the end forming the radiating aperture being fitted with a rod made of dielectric material, said rod being partly inserted into the waveguide and filling the section of the waveguide over a defined length, wherein a part of the rod is extended beyond the waveguide over a length less than twice the guided wavelength with the section of the rod developing outside the waveguide differently in each of the planes.

2. Antenna according to claim 1, wherein the development of the section of the rod outside the waveguide is linear but in a different direction in each of the two planes.

3. Antenna according to claim 1, wherein in one of the planes, the rod becomes larger and in the other plane the rod becomes smaller.

4. Antenna according to claim 1, wherein the waveguide is of square, rectangular or circular section.

5. Antenna according to claim 4, wherein the end of the rod located outside the waveguide has a section with a shape different from the section of the waveguide.

6. Antenna according to claim 5, wherein the section of the waveguide is square and the section of the end of the rod located outside the waveguide is rectangular.

7. Antenna according to claim 1, wherein the part of the rod located inside the waveguide ends with an impedance matching area consisting of a conical trunk having the same section as the waveguide.

8. Antenna according to claim 1, wherein the waves that circulate in the waveguide are polarized waves.

9. Antenna according to claim 8, wherein the polarized waves are of linear polarizations perpendicular to the axis of propagation of the waves and in two different directions, each direction being included in one of the two planes, and the shape of the rod outside the waveguide being symmetrical in relation to each of the two planes.

10. Antenna according to claim 1, wherein the rod is extended outside the guide over a length less than the wavelength.
